(19) United States
(12) Patent Application Publication
(10) Pub. No.: US 2005/0276485 A1
(43) Pub. Date: Dec. 15, 2005

(54) Pattern recognition system utilizing an expression profile

(75) Inventors: Atsushi Mori, Tokyo (JP); Daisuke Sakurai, Tokyo (JP); Ayako Fujisaki, Tokyo (JP)

Correspondence Address: Reed Smith LLP, 3110 Fairview Park Drive, Suite 1400, Falls Church, VA, 22042-4503, US

(73) Assignee: Hitachi Software Engineering Co., Ltd.

(21) Appl. No.: 11/130,149

(22) Filed: May 17, 2005

(30) Foreign Application Priority Data
Jun. 10, 2004 (JP) 2004-172898

(51) Int. Cl. G06K 9/62

(52) U.S. Cl. 382/228; 382/159

(57) ABSTRACT

When making a clinical diagnosis using gene expression profiles or the like obtained from a DNA microarray, multidimensional data is visualized on a scatter chart so that outliers can be identified and the state of classifications can be recognized. A method comprises calculating said separating hyperplane by applying said pattern recognition algorithm to said training set that is entered; displaying the labels of two axes of said scatter chart in two or three dimensions; applying data of which the group it belongs to is unknown to said pattern recognition algorithm as a test set in order to determine the group the data belongs to; displaying a plot representing the data in said training set and a plot representing the data in said test set on a two- or three-dimensional scatter chart, in different manners for individual groups; and displaying said separating hyperplane by mapping it to said scatter chart.

### CLAIM OF PRIORITY

The present application claims priority from Japanese application JP 2004-172898 filed on Jun. 10, 2004, the content of which is hereby incorporated by reference into this application.

### BACKGROUND OF THE INVENTION

1. Field of the Invention

The present invention relates to a method for displaying the result of pattern recognition determination, and more particularly to a technique for visualizing multidimensional data about gene expression profiles in a DNA microarray or protein expression profiles in a protein chip, separating a hyperplane obtained by a pattern recognition algorithm, and the result of determination by a pattern recognition algorithm.

2. Background Art

Pattern recognition algorithms are being studied from a long time ago whereby a separating hyperplane is determined by using vectors and the ID of the group they belong to as an item of training data, and using two or more groups and the multiple items of training data that belong to the individual groups as a training set. These algorithms have been applied to the recognition of patterns such as the visual pattern of hand-written character data or the face of humans, or the speech pattern for the purpose of converting voices into characters, for example. In recent years, attempts are being made to apply pattern recognition algorithms to the gene expression profiles obtained in DNA microarrays in order to predict diseases such as acute myelocytic leukemia and acute lymphatic leukemia, which are cytomorphologically difficult to distinguish, or to predict the drug response in anticancer drugs, which have large individual differences in pharmacological effect. Patent Document 1 describes a method for identifying gene groups contributing to the division of groups, such as the types of cancer, from gene expression profiles obtained in a microarray or the like, using a test, for example.

Patent Document 1: JP Patent Publication (Kokai) No. 2003-304884 A

### SUMMAR OF THE INVENTION

In the conventional visual pattern recognition of hand-written character data or the human faces, or the speech pattern recognition for converting voices into characters, the data dimensions have a strong correlation and there is not much significance in displaying the multidimensional data in a two-dimensional plane. Therefore, the existing data mining software for the general users and some gene expression statistical analysis software do not display training sets, separating hyperplanes, or determination results in the form of a scatter diagram. Instead, most of them only display determination results in terms of P values in a list, for example, and if the determination results are to be displayed in a scatter diagram, principal component analysis or the like must be employed. However, in the case of gene expression profiles obtained in a DNA microarray, for example, each dimension of the data is a gene when performing a pattern recognition in the direction of experiments (chips). On the other hand, in the case of principal component analysis, each axis is not an individual gene, which is not appropriate as a mining technique for gaining new insights.

However, the number of relevant genes, even in multifactorial disorders, are thought to be several to dozens at most, so that it can be expected that the gaining of new insights could be facilitated by focusing on one to several genes with particularly strong relevance and visually recognizing their training sets, separating hyperplanes, or determination results in a scatter diagram.

The aforementioned problems are solved by the invention in the following manner. Using vectors and the ID of a group they belong to as a piece of training data, and using two or more groups and the multiple training data items that belong to the individual groups as a training set, a separating hyperplane is determined using a pattern recognition algorithm. Examples of the pattern recognition algorithm include SVM (Support Vector Machine) capable of determining an optimum solution (C. Cortes, V. Vapnik: Support-Vector Networks, Machine Learning” 20(3): 273-297, September 1995), MLP (Multi-Layer Perceptron) (Rumelhart, et al.: “Learning internal representations by error propagation” The M.I.T. Press, pp. 318-362, 1986), which is s typical neural network, or k-NN (k-Nearest Neighbors), which utilizes k items of training data nearest to test data. When selecting the dimensions for causing multidimensional data to be displayed on a two-dimensional plane or a three-dimensional space, the dimensions (which are genes when the classifications is in the direction of experiments) contributing to the division of the groups are ranked by increasing order of P values, using t-test or Mann-Whitney test in the case of two groups, or ANOVA (variance analysis) or Kruscal-Wallis test in the case of multiple groups, based on the null hypothesis that “the groups are not significantly divided.” Then, when the dimensions are selected, the axes of the scatter chart can be selected from the genes that have been ranked. The groups are automatically distinguished by different colors, so that the recognition of the regions of the individual groups can be facilitated by the gradational representation and the mapping of the separating hyperplane.

Further, the invention provides a visual mining capability allowing the display of the scatter chart to be updated by automatically selecting the combination of the axes from the top of the ranked genes, thereby facilitating the user's recognition of outliners in the data or the state of classifications, or the gaining of new knowledge from the combination of the genes.

In accordance with the invention, the recognition of outliners or the state of classifications by the user can be facilitated by visualizing the separating hyperplane obtained from the training set and the pattern recognition algorithm. In particular, in the case of pattern recognition using a gene expression profile obtained from a DNA microarray, or a protein expression profile obtained from a protein chip, after the genes or proteins contributing to the division of groups are ranked using a test method, the axes are selected by the user or the top axes in the ranking are automatically combined. In this way, the invention allows the user to recognize the state of classifications by specific genes or proteins or the presence of outliners, thus facilitating the gaining of new knowledge.

Furthermore, the relative magnitudes of the values of the determination results are displayed in a displayed list with different colors that are automatically allocated to the groups of the training set in advance, thereby allowing the degree of the determination result to the multiple groups to be recognized at a glance.

### BRIEF DESCRIPTION OF THE DRAWINGS

FIG. 1 shows an example of the configuration of a system of the invention.

FIG. 2 shows the structure of a table of a training set and a test set.

FIGS. 3A to 3C show the concept of how dimensions are ranked.

FIG. 4 shows a scatter chart in a two-dimensional plane.

FIG. 5 shows an example of a screen for selecting the axes of a two-dimensional plane.

FIG. 6 shows a scatter chart in a three-dimensional space.

FIG. 7 shows an example of a screen for selecting the axes of the three-dimensional space.

FIG. 8 shows a main flowchart.

FIG. 9 shows a flowchart for creating a classifier.

FIG. 10 shows a flowchart for designating axes.

FIG. 11 shows a flowchart for displaying a scatter chart.

FIG. 12 shows a flowchart for displaying a determination result.

FIG. 13 shows a flowchart of a data selection process.

### DESCRIPTION OF PREFERRED EMBODIMENTS

The invention will be described by way of an embodiment with reference made to the drawings.

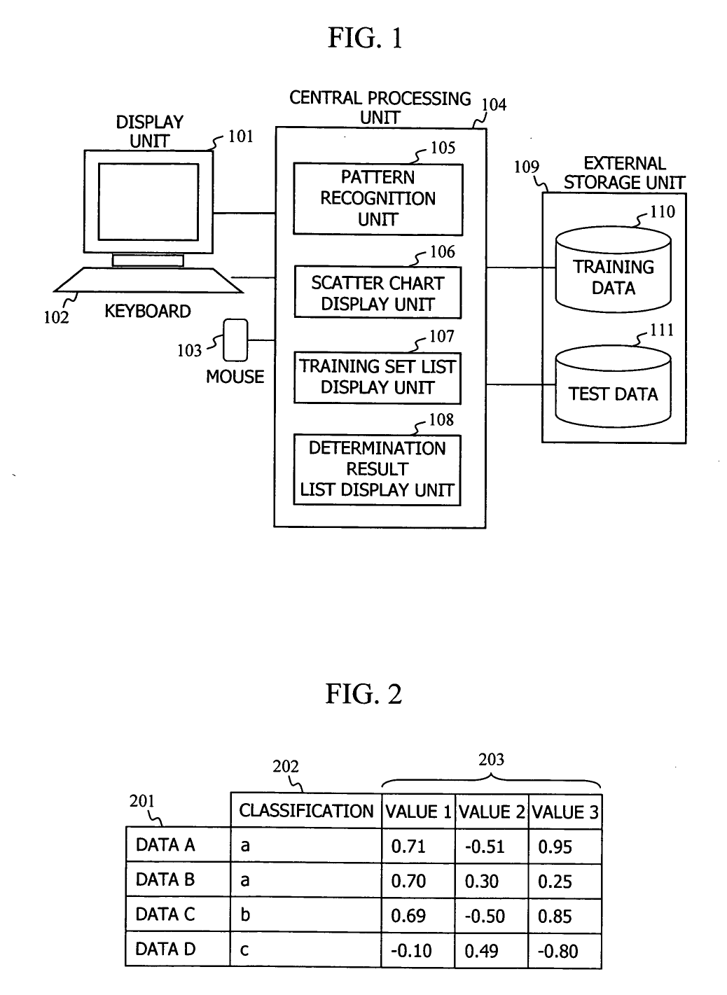

FIG. 1 shows the configuration of a system in an embodiment of the invention. The system comprises, as shown, a central processing unit 104 for processing the input and output of training data or test data and pattern recognition, a display unit 101 with a character and graphic screen, a keyboard 102, a mouse 103, and an external storage unit 109 for storing training data or test data. The central processing unit 104 includes a pattern recognition unit 105, a scatter chart display unit 106, a training set list display unit 107, and a determination result list display unit 108.

The pattern recognition unit 105, using a set of two or more classifications in the training data 110 as a training set, creates a classifier using a variety of pattern recognition algorithms, such as SVM, MLP, k-NN and a decision tree. The pattern recognition unit 105 inputs test data into the thus created classifier and then outputs determination results. The scatter chart display unit 106 displays a separating hyperplane, which is the boundary between the training set and the classifications in the classifier, and the test data in a scatter chart. The training set list display unit 107 displays training sets in a list, such as information about samples or experiments in the case of a DNA microarray, for example. The determination result list display unit 108 displays values indicating the proximities to individual classifications, namely, the result of feeding training data into the classifier, and the name of a classification with the highest score in the displayed values to which a single training data item has been predicted to belong. The pattern recognition unit 105, scatter chart display unit 105, training set list display unit 107, and determination result list display unit 108 can be implemented using a software program.

The external storage unit 109 includes databases of training data and test data. The training data 110 is data whose classifications are known from the biological evidence. The test data 111 is data with unknown classifications. While in a clinical diagnosis, classifications of experiments (such as chips in the case of DNA microarrays) are predicted, the invention makes it also possible to predict classifications in the opposite direction, namely, the classifications of genes or proteins.

FIG. 2 shows the structure of a table in which data consisting of training data and test data are stored in the present embodiment. Numeral 201 designates areas for storing data IDs distinguishing individual pieces of data, namely, the IDs of experiments or chips in the case of clinical diagnosis where the classification is by experiments, or the IDs of genes when predicting the functions of genes with unknown functions. Numeral 202 designates areas for storing the IDs of the classifications to which data belong, where the assumption is that the individual pieces of training data only belong to single classifications. In the case of test data, the areas 202 are vacant prior to determination; after determination, the IDs of the determined classifications are stored. Numeral 203 designates areas for storing the individual values contained in the data shown in the row direction, the values representing the log ratios of fluorescent intensities in two channels in the case of a gene expression profile, for example.

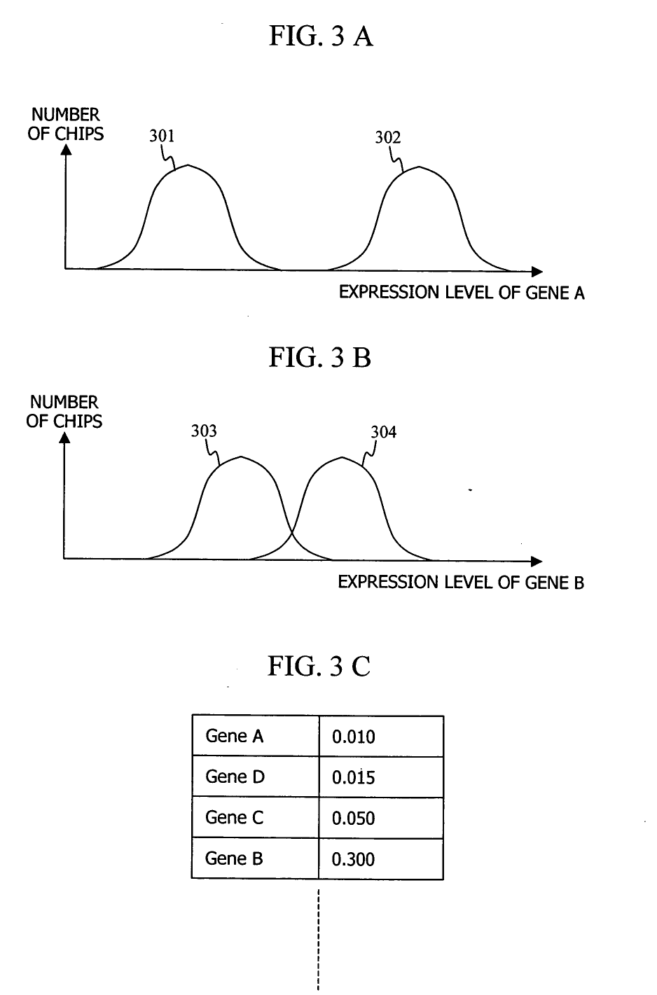

FIGS. 3A to 3C schematically show a method of ranking genes using a test method. Numerals 301 and 303 designate Group 1 and numerals 302 and 304 designate Group 2. When only the expression values of gene A are observed, as shown in FIG. 3A, the two groups are separate, while when only the expression values of gene B are observed, as shown in FIG. 3B, the two groups are not quite separate. The results are the P values shown in FIG. 3C, where it can be seen that genes with smaller P values contribute more to the division of the groups.

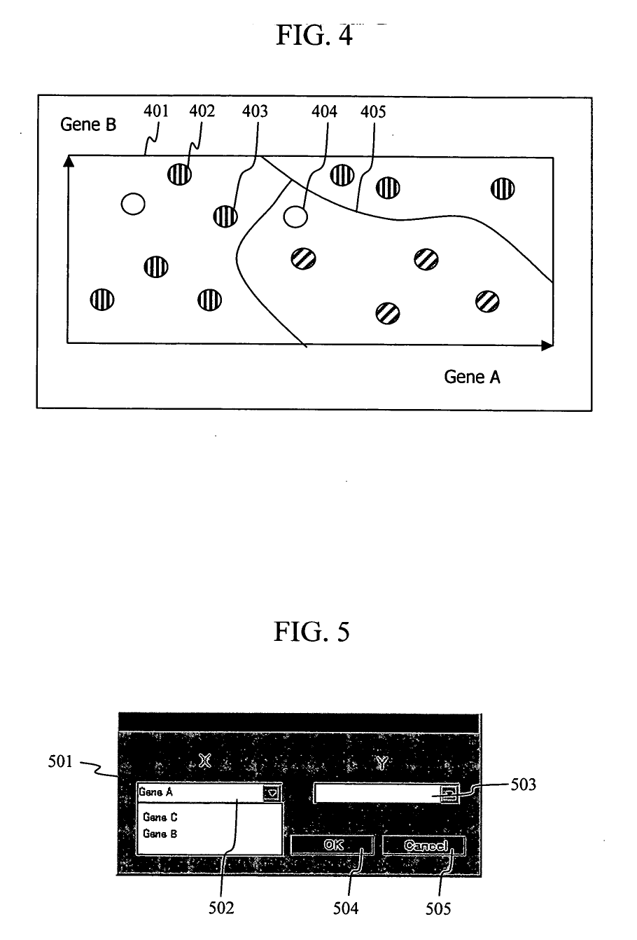

FIG. 4 schematically shows a scatter chart on a two-dimensional plane, where genes or proteins constitute the axes when the classifications are by experiments, as shown. In FIG. 4, numeral 401 designates the entire scatter chart, in which, after the selection of an axis, plotted areas are specified by determining the minimum and maximum values of each axis. A training data plot 402 is automatically painted in a color indicating each classification. Plot 403 is displayed such that it can be visually recognized to be training data defining the boundary of classification when SVM, which is one of pattern recognition algorithms, is used, and so that particularly the fact that the data is a support vector can be known. Test data 404 is displayed in a different manner and with a separate color from training data, such that determination results can be known. Numeral 405 indicates a line mapping the separating hyperplane on the scatter chart. Even in those algorithms where the separating hyperplane is not explicitly defined, such as in the case of k-NN, the separating hyperplane can be determined by plotting determination values at individual points in a graph with sufficiently fine coordinate resolution, and then drawing a contour using a general contour drawing algorithm.

FIG. 5 shows an example of a screen for selecting axes, which are selected from the elements ranked by a test method, as will be described later with reference to a flowchart. Although in FIG. 5 a selection screen 501 is shown in the form of a dialog, this is merely one example of how the axes are set, and it is also possible to control the selection within the window in a GUI fashion. Controls 502 and 503 are for displaying the axes ranked in advance in a drop-down list, for example. The list, which could possibly contain tens of thousands of items in the case of genes, is scrollable and is adapted to initially display the top ten or so items in the ranking. When the setting is to be done in the form of a dialog, a change in the axis can be reflected via an OK button 504, and the change can be nullified via a cancel button 505.

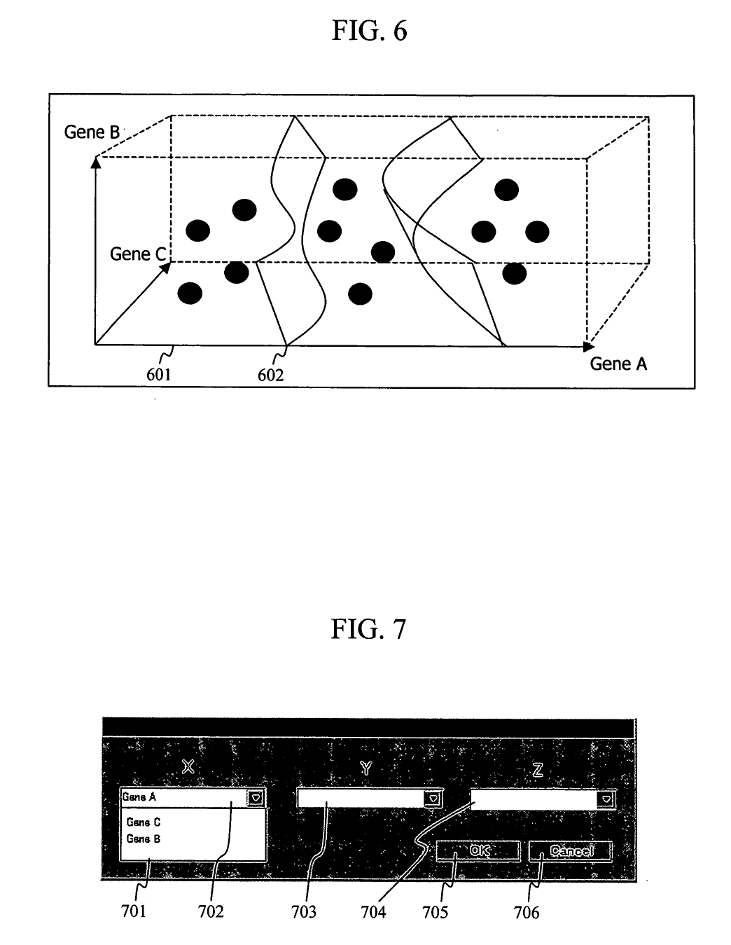

FIG. 6 schematically shows a scatter chart in a three-dimensional space, in which the axes are constituted by genes or proteins when the classification is by experiments, as shown. In a scatter chart 601, three axes are selected and then the minimum and maximum values of each axis are determined to define a plotted region. The manner that the individual points of data are displayed is the same as that in the case of the two-dimensional plane. Numeral 602 is a curve mapping a separating hyperplane to the scatter chart. Even in those algorithms where the separating hyperplane is not explicitly defined, such as in the case of k-NN, the separating hyperplane can be determined by plotting determination values at individual points in a graph with sufficiently fine coordinate resolution, and then drawing a contour using a general contour drawing algorithm.

FIG. 7 shows an example of a screen for selecting the axes, which are selected from the elements ranked by a test method, as will be described later with reference to a flowchart. Although in FIG. 5 a selection screen 701 is shown in the form of a dialog, this is merely one example of how the axes are set, and it is also possible to control the selection within the window in a GUI fashion. Controls 702, 703, and 704 are for displaying the axes ranked in advance in a drop-down list, for example. The list, which could possibly contain tens of thousands of items in the case of genes, is scrollable and is adapted to initially display the top ten or so items in the ranking. When the setting is to be done in the form of a dialog, a change in the axis can be reflected via an OK button 705, and the change can be nullified via a cancel button 706.

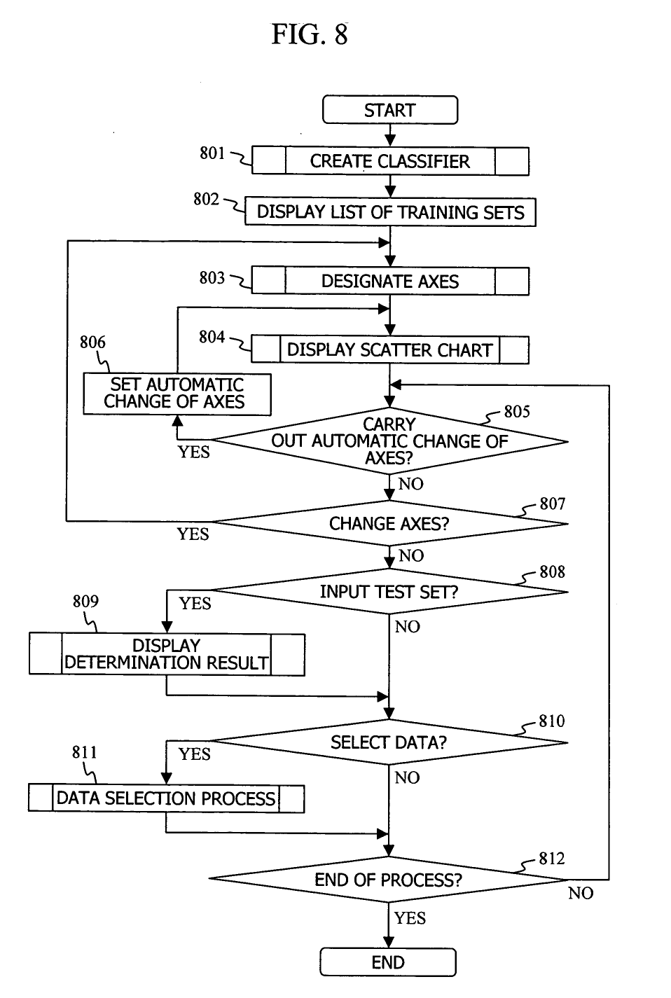

FIG. 8 shows a main flowchart of the processes performed by the invention, with reference to which the embodiment of the invention will be described in greater detail below. Prior to the start of the flowchart, it is indispensable in the invention to define a training set with known classifications, a pattern recognition algorithm, and the parameters of the pattern recognition algorithm. However, test data is not necessarily indispensable. In an actual operation, it is possible that the method of narrowing the gene groups in a training set, the pattern recognition algorithm, and its parameters are determined through a process of trial and error. Thus, it should be noted that a data mining process is not complete with the present flowchart.

Initially, a classifier is created in step 801. This process is performed in the pattern recognition unit 105 shown in FIG. 1. The details will be described later. Numeral 802 designates the step of displaying a training set in a list. In this step, the training set specified in the classifier-creating step is displayed prior to a scatter chart. This process is performed in the training set list display unit 107. Numeral 803 designates the step of specifying the axes performed in the scatter chart display unit 106 shown in FIG. 1, of which the details will also be described later. Numeral 804 designates the step of displaying the scatter chart performed in the scatter chart display unit 106, of which the details will be described later.

In step 805, if the user of the system executes an automatic change of the axes, the routine proceeds to step 806. If not, the routine proceeds to step 807. Whether or not such change is to be executed is controlled via a GUI operation in a menu on the window, for example. In step 806, conditions regarding the automatic change of axes are set. When the user enters settings concerning an test method, such as t-test, Mann-Whitney test, ANOVA, or Kruscal-Wallis test, and how many elements at the top of the P value ranking is to be used, the scatter chart display unit 106 causes the scatter chart to be repeatedly displayed as many times as the number of combinations of the dimensions of the number of elements.

In step 807, if the user changes the axis, the routine returns to step 803. If not, the routine proceeds to step 808. In step 808, if the user enters a test set in the classifier, the routine proceeds to step 809, and if not, to step 810.

Numeral 809 designates the step of displaying the determination result, of which the details will be described later. After step 809 is performed, the routine proceeds to step 810, in which if the user is to select data, the routine proceeds to step 811, and if not, to step 812. Numeral 811 designates the step of selecting data, of which the details will also be described later. After step 811 is performed, the routine proceeds to step 812, in which if the user chooses to end the routine, the flowchart ends, and if not, the routine returns to step 805.

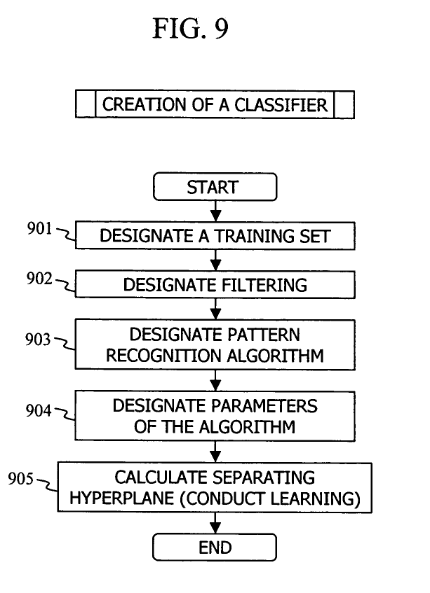

FIG. 9 shows a flowchart illustrating the process of creating a classifier in step 801 in detail.

In step 901, a training set consisting of two or more groups that are not vacant with known classifications is selected, and then the routine proceeds to step 902. In step 902, filtering is designated. Generally, when making a clinical diagnosis based on a gene expression profile obtained from a DNA microarray or the like, related gene groups are narrowed, using an algorithm similar to the one used for ranking the genes when selecting the axes of the scatter chart. Currently, there is no definitive technique for this purpose. After the designation is made, the routine proceeds to step 903.

In step 903, a pattern recognition algorithm is designated. In terms of the general pattern recognition rate, SVM is superior both theoretically and in practical calculations. However, if the black box of machine learning is to be avoided, k-NN or a decision tree may be used. After an algorithm is designated, the routine proceeds to step 904, in which the parameters of the algorithm designated in step 903 are defined. Thereafter, the routine proceeds to step 905.

In step 905, when the pattern recognition algorithm is a learning algorithm, learning is conducted. When it is a non-learning algorithm, the algorithm and its parameters are applied to the individual coordinates in the scatter chart and a contour line is plotted so as to calculate a separating hyperplane. This completes the flow of creation of a classifier.

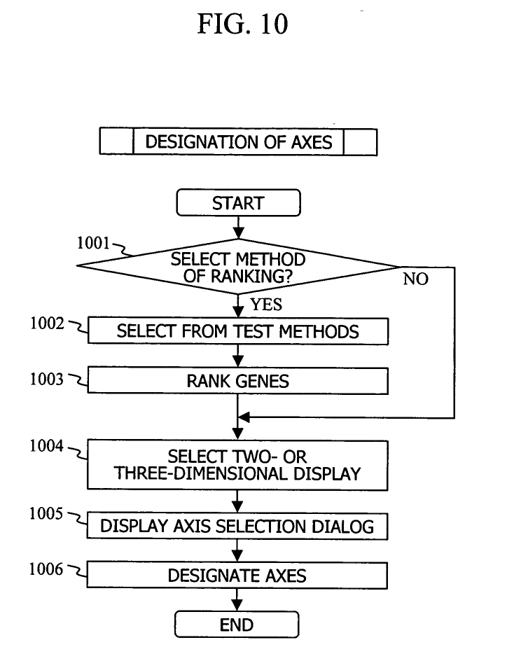

FIG. 10 shows a flowchart showing the axis designating process in step 803 in detail.

In the selection of a ranking method in step 1001, if the user selects a ranking method, the routine proceeds to step 1002. If not, the routine proceeds to step 1004, and the existing ranking remains. (If no ranking has been made, the initial order is adopted.) In step 1002, a ranking method is selected depending on the test method, for example. Thereafter, the routine proceeds to step 1003, where the genes are ranked using the ranking method designated in step 1002. The routine then proceeds to step 1004.

In step 1004, it is determined whether a scatter chart is displayed two-dimensionally or three-dimensionally. The routine then proceeds to step 1005 where an axis selection dialog is displayed. The routine then proceeds to step 1006 where the axes are designated, thereby completing the flow of the designation of axes.

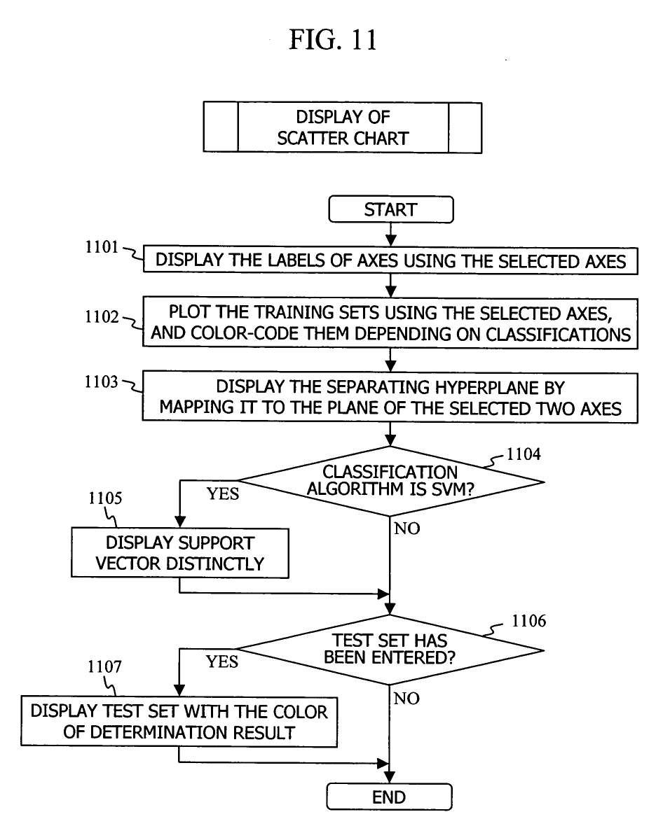

FIG. 11 shows a flowchart showing the scatter chart display process in step 804 in detail.

In step 1101, the labels of the axes are displayed using the axes that have already been selected. Thereafter, the routine proceeds to step 1102 where the training sets are plotted with different colors for individual classifications. Then, in step 1103, the separating hyperplane is displayed by mapping it to the plane (or a space in the case of a 3D scatter chart) of the selected two axes. In step 1104, if the classification algorithm is SVM, the routine proceeds to step 1105 where the support vector is displayed in a distinct manner, and the routine then proceeds to step 1106. If the algorithm is not SVM in step 1104, the routine proceeds to step 1106.

In step 1106, if the test set has been entered, the routine proceeds to step 1107, and if not, the flowchart ends. In step 1107, the test set is plotted on the scatter chart and displayed in the determination result display list with the color of the determination result. This completes the flowchart for displaying the scatter chart.

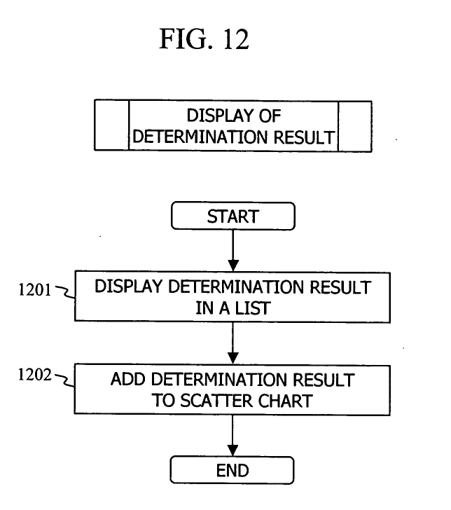

FIG. 12 shows a flowchart showing the determination result display process in step 809 in detail.

In step 1201, the determination result is displayed in the determination result display list with the color of the determination result. The routine then proceeds to step 1202 where the determination result is added to the scatter chart. This completes the flowchart for displaying the determination result.

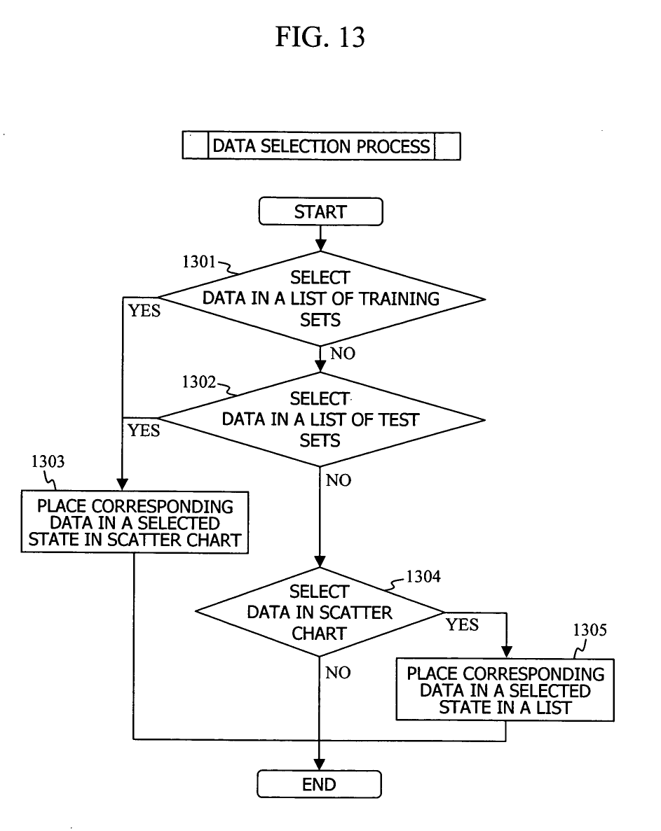

FIG. 13 shows a flowchart showing the data selection process in step 811 in detail.

In step 1301, if the user selects data from the list of training sets, the routine proceeds to step 1303. If not, the routine proceeds to step 1302 where if the user selects data from the list of the test sets, the routine proceeds to step 1303. If not, the routine proceeds to step 1304. In step 1303, a plot corresponding to the data selected in the list is placed in a selected state, and then the flowchart ends.

In step 1304, if the user selects data in the scatter chart, the routine proceeds to step 1305, and if not, the flowchart ends. In step 1305, the data corresponding to the data selected in the scatter chart is placed in a selected state in the list, which completes the flowchart of the data selection process.

1. A method of displaying a scatter chart using a processing unit comprising:
means for applying two or more groups of a plurality of items of data consisting of values of a plurality of dimensions to a pattern recognition algorithm as a training set, and calculating a separating hyperplane that is the boundary of the individual groups; and
means for displaying a mapping of the plot representing each data item and said separating hyperplane on a two-dimensional scatter chart, wherein said processing unit carries out the steps of:
calculating a separating hyperplane by applying a pattern recognition algorithm to a training set that is entered;
displaying the labels of two axes of said scatter chart in two dimensions;
applying data of which the group it belongs to is unknown to said pattern recognition algorithm as a test set in order to determine the group the data belongs to;
displaying a plot representing the data in said training set and a plot representing the data in said test set on a two-dimensional scatter chart having said two dimensions as the axes thereof, in different manners for individual groups; and
displaying said separating hyperplane by mapping it to said two-dimensional scatter chart.

2. A method of displaying a scatter chart using a processing unit comprising:
means for applying two or more groups of a plurality of items of data consisting of values of a plurality of dimensions to a pattern recognition algorithm as a training set, and calculating a separating hyperplane that is the boundary of the individual groups; and
means for displaying a mapping of the plot representing each data item and said separating hyperplane on a two-dimensional scatter chart, wherein said processing unit carries out the steps of:
calculating a separating hyperplane by applying a pattern recognition algorithm to a training set that is entered;
displaying the labels of three axes of said scatter chart in three dimensions;
applying data of which the group it belongs to is unknown to said pattern recognition algorithm as a test set in order to determine the group the data belongs to;
displaying a plot representing the data in said training set and a plot representing the data in said test set on a three-dimensional scatter chart having said three dimensions as the axes thereof, in different manners for individual groups; and
displaying said separating hyperplane by mapping it to said three-dimensional scatter chart.

3. The method of displaying a scatter chart according to claim 1, wherein said processing unit carries out the steps of causing a plurality of dimensions that are candidates for the axes of said scatter chart to be displayed and prompting the entry of an input.

4. The method of displaying a scatter chart according to claim 2, wherein said processing unit carries out the steps of causing a plurality of dimensions that are candidates for the axes of said scatter chart to be displayed and prompting the entry of an input.

5. The method of displaying a scatter chart according to claim 1, wherein said processing unit carries out the steps of:
receiving a designation of the top N dimensions in the ranked list of dimensions; and
automatically selecting a particular dimension from the thus designated N dimensions and updating the display of said scatter chart.

6. The method of displaying a scatter chart according to claim 2, wherein said processing unit carries out the steps of:
receiving a designation of the top N dimensions in the ranked list of dimensions; and
automatically selecting a particular dimension from the thus designated N dimensions and updating the display of said scatter chart.

7. A program for causing a computer to carry out the steps of:
applying two or more groups of a plurality of items of data consisting of values of a plurality of dimensions to a pattern recognition algorithm as a training set, and calculating a separating hyperplane that is the boundary of the individual groups; and
displaying the labels of two axes of said scatter chart in two dimensions;
applying data of which the group it belongs to is unknown to said pattern recognition algorithm as a test set in order to determine the group the data belongs to;
displaying a plot representing the data in said training set and a plot representing the data in said test set on a two-dimensional scatter chart having said two dimensions as the axes thereof, in different manners for individual groups; and
displaying said separating hyperplane by mapping it to said two-dimensional scatter chart.

8. A program for causing a computer to carry out the steps of:
applying two or more groups of a plurality of items of data consisting of values of a plurality of dimensions to a pattern recognition algorithm as a training set, and calculating a separating hyperplane that is the boundary of the individual groups; and
displaying the labels of three axes of said scatter chart in three dimensions;
applying data of which the group it belongs to is unknown to said pattern recognition algorithm as a test set in order to determine the group the data belongs to;
displaying a plot representing the data in said training set and a plot representing the data in said test set on a three-dimensional scatter chart having said three dimensions as the axes thereof, in different manners for individual groups; and
displaying said separating hyperplane by mapping it to said three-dimensional scatter chart.

9. The program according to claim 7, further causing the computer to carry out the step of causing a plurality of dimensions that are candidates for the axes of said scatter chart to be displayed on said display means, and prompting the entry of an input.

10. The program according to claim 8, further causing the computer to carry out the step of causing a plurality of dimensions that are candidates for the axes of said scatter chart to be displayed on said display means, and prompting the entry of an input.

11. The program according to claim 7, further causing the computer to carry out the steps of:
receiving a designation of the top N dimensions in the ranked list of dimensions; and
automatically selecting a particular dimension from the thus designated N dimensions, and updating the display of said scatter chart.

12. The program according to claim 8, further causing the computer to carry out the steps of:
receiving a designation of the top N dimensions in the ranked list of dimensions; and
automatically selecting a particular dimension from the thus designated N dimensions, and updating the display of said scatter chart.
